(19) United States
(12) Patent Application Publication
(10) Pub. No.: US 2022/0146344 A1
(43) Pub. Date: May 12, 2022

(54) SINGLE PLANE POWERTRAIN SENSING USING VARIABLE RELUCTANCE SENSORS

(71) Applicant: LORD Corporation, Cary, NC (US)

(72) Inventors: Mark R. Jolly, Raleigh, NC (US); Daniel E. Kakaley, Cary, NC (US); Russell E. Altieri, Holly Springs, NC (US)

(21) Appl. No.: 17/582,363

(22) Filed: Jan. 24, 2022

Related U.S. Application Data
(63) Continuation of application No. PCT/US2020/043496, filed on Jul. 24, 2020.
(60) Provisional application No. 62/878,028, filed on Jul. 24, 2019.

(51) Int. Cl. G01L 3/10; G01K 7/16

(52) U.S. Cl. CPC G01L 3/101; G01K 7/16

(57) ABSTRACT

Systems and methods for measuring twist on a shaft of a rotating drive system include a first set of targets circumferentially distributed around the shaft at a first axial location to rotate with the shaft and a second set of targets circumferentially distributed around the shaft at a second axial location to rotate with the shaft. The first and second sets of targets are interleaved. The system includes a sensor assembly including one or more sensors mounted around the shaft and configured to detect the first and second sets of targets as the shaft rotates. The system includes a sensor processing unit for receiving an electrical waveform from the sensor assembly, determining, based on the electrical waveform, a twist measurement of twist motion between the first axial location and the second axial location on the shaft, and determining, based on the electrical waveform, a second measurement of shaft motion.

### CROSS-REFERENCE TO RELATED APPLICATIONS

This application is a continuation of and claims priority to PCT Application Serial No. PCT/US2020/043496, which was filed Jul. 24, 2020, which claims priority to U.S. Provisional Patent Application Ser. No. 62/878,028, which was filed Jul. 24, 2019, the disclosures of which are incorporated herein by reference.

### TECHNICAL FIELD

The subject matter disclosed herein relates to methods and systems for measuring twist between two locations on a rotating shaft, for example, using two sets of interleaved ferrous targets.

### BACKGROUND

Methods for torque measurement using variable reluctance (VR) sensors to measure twist across a shaft segment are well-known. Typically, a reference tube is used in conjunction with ferrous target teeth to assess twist across a length of shaft. Variable reluctance (VR) sensors are employed to measure changes in the timing of pulses produced by the passage of the ferrous targets. Twist in the shaft can be related to the relative change in pulse timing. Then, by knowing the torsional spring rate of the shaft, torque can be derived from twist.

There is a need to provide highly accurate twist measurement on a rotating shaft as well as multi-axis shaft motion with a light weight and minimally invasive solution. Monopole VR sensor-based solutions are light weight and minimally invasive but have limitations in terms of provided twist measurement accuracy. Multi-plane sensing solutions can often provide high twist accuracy as well as measurement of additional shaft motions, but typically require more than three VR sensors disposed across multiple measurement planes and can present integration challenges.

### SUMMARY

Systems and methods for measuring twist on a shaft of a rotating drive system are disclosed. In some aspects, a system includes a first set of targets circumferentially distributed around the shaft at a first axial location and configured to rotate with the shaft and a second set of targets circumferentially distributed around the shaft at a second axial location and configured to rotate with the shaft. The first and second sets of targets are interleaved. The system includes a sensor assembly including one or more sensors mounted around the shaft and configured to detect the first and second sets of targets as the shaft rotates. The system includes a sensor processing unit configured for receiving an electrical waveform from the sensor assembly; determining, based on the electrical waveform, a twist measurement of twist motion between the first axial location and the second axial location on the shaft; and determining, based on the electrical waveform, a second measurement of shaft motion. Based on the product of shaft stiffness and twist, the shaft torque can be calculated.

In some aspects, a system includes a first set of targets circumferentially distributed around a shaft of a rotating drive system at a first axial location and configured to rotate with the shaft and a second set of targets circumferentially distributed around the shaft at a second axial location and configured to rotate with the shaft. Each target of a subset of the first and second sets of targets is slanted in an axial direction. The system includes a sensor assembly comprising one or more sensors mounted around the shaft at a single axial location and configured to detect the first and second sets of targets as the shaft rotates. The system includes a sensor processing unit configured for determining, using the sensor assembly and the subset of the first and second sets of targets slanted in the axial direction, a measurement of torque on the shaft.

### BRIEF DESCRIPTION OF THE DRAWINGS

FIGS. 1A and 1B show an example sensor system for measuring twist between two locations on a rotating shaft using two sets of interleaved ferrous targets;

FIGS. 2A and 2B show another example sensor system for measuring twist using cantilevered shaft attachments;

FIG. 3 is a diagram illustrating interleaved reference and torque targets;

FIGS. 4A and 4B are diagrams illustrating target timing with and without radial offset;

FIG. 5 is a chart illustrating tangential length between targets as a function of radial offset;

FIG. 6 is a diagram illustrating interleaving targets with two VR sensors;

FIG. 7 is a chart showing a time series of twist values; the signal with the higher SNR is rejecting the common mode noise via a differential measurement;

FIG. 8 is a histogram of twist algorithms with common mode noise;

FIGS. 9A and 9B illustrate accommodating relative radial offset between target wheels;

FIG. 10 shows a single target and VR sensor and provides associated vector math;

FIG. 11 illustrates angled targets to enable measurement of axial motion;

FIG. 12 is a signal processing diagram for a system configured to calculate the torque applied to a shaft;

FIG. 13 is a diagram showing an unraveled set of targets passing a VR sensor;

FIG. 14 is a signal processing diagram for a system augmented to detect axial motion;

FIG. 15 is a diagram showing an unraveled set of targets (some of which are slanted) passing a VR sensor;

FIG. 16 is a signal processing diagram of a system configured for processing two sensor signals to achieve a more accurate torque measurement;

FIG. 17 is a diagram showing an unraveled set of targets passing two VR sensors;

FIG. 18 is a signal processing diagram for an example system using dual sensors and axial/slanted teeth to output torque;

FIG. 19 is a signal processing diagram for an example system using three sensors;

FIG. 20 is a signal processing diagram for an example system for triple sensor torque with axial/slanted teeth; and

FIG. 21 is a block diagram illustrating a system for redundantly calculating a torque applied to the shaft to meet a safety criticality threshold of accuracy.

### DETAILED DESCRIPTION

This specification describes systems and methods for methods and systems for measuring twist between two locations on a rotating shaft, for example, using two sets of interleaved ferrous targets.

Some conventional methods for torque measurement use variable reluctance (VR) sensors to measure twist across a shaft segment. Typically, a reference tube is used in conjunction with ferrous target teeth to assess twist across a length of shaft. Variable reluctance (VR) sensors are employed to measure changes in the timing of pulses produced by the passage of the ferrous targets. Twist in the shaft can be related to the relative change in pulse timing. Then, by knowing the torsional spring rate of the shaft, torque can be derived from twist.

Two-plane torque sensing is also used in some conventional systems. This technology utilizes two target disks separated axially on the shaft by a distance. Each target disk is surrounded by a minimum of three VR sensors. A total of six VR sensors are used so that radial motion in two plane is measured and can be factored out of the shaft twist measurement. The approach has proven to be robust in applications with significant lateral shaft movement and large clearance gaps. It has the added benefit of providing measurements of lateral shaft movement. These systems tend to be costly and complex.

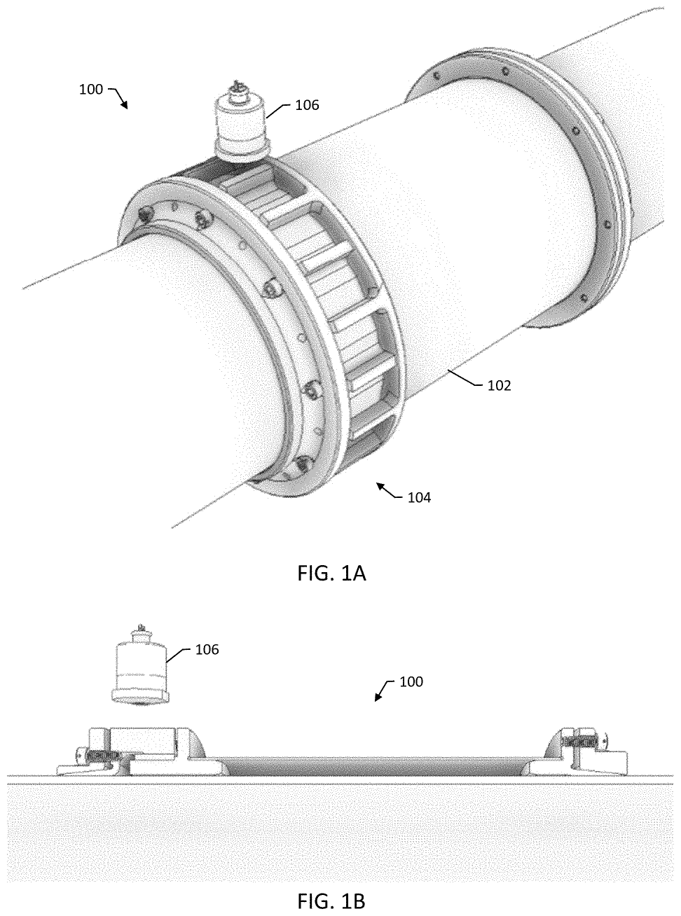

FIGS. 1A and 1B show an example sensor system 100 for measuring twist between two locations on a rotating shaft 102 using two sets of interleaved targets 104 using a sensor 106. The targets can be ferrous or non-ferrous. A non-limiting example of a non-ferrous target is one made out of Inconel. The system uses a reference tube with one end attached at a first position on a shaft and another distal end with attached measurement targets. Reference targets are attached at a second position on the shaft whereby the reference targets and measurement targets are interleaved. Relative tangential motion between the reference targets and measurement targets will correspond to twist across the shaft between the first and second position.

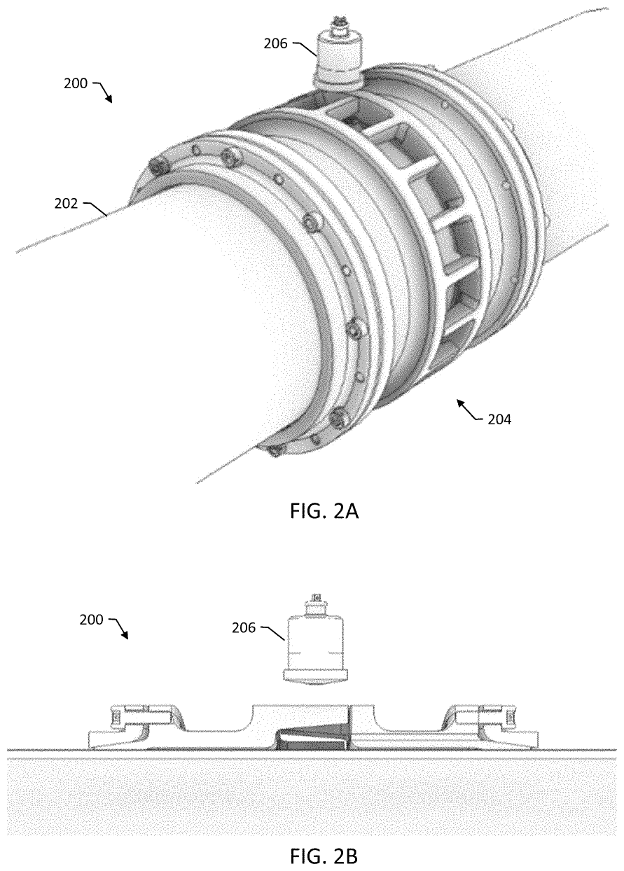

FIGS. 2A and 2B show another example sensor system 200 for measuring twist using cantilevered shaft attachments. The system includes two tube segments attached to the shaft 202 at first and second positions. The system includes interleaved ferrous targets 204 and a sensor 206. Relative tangential motion between the two sets of targets will correspond to twist across the shaft between the first and second positions.

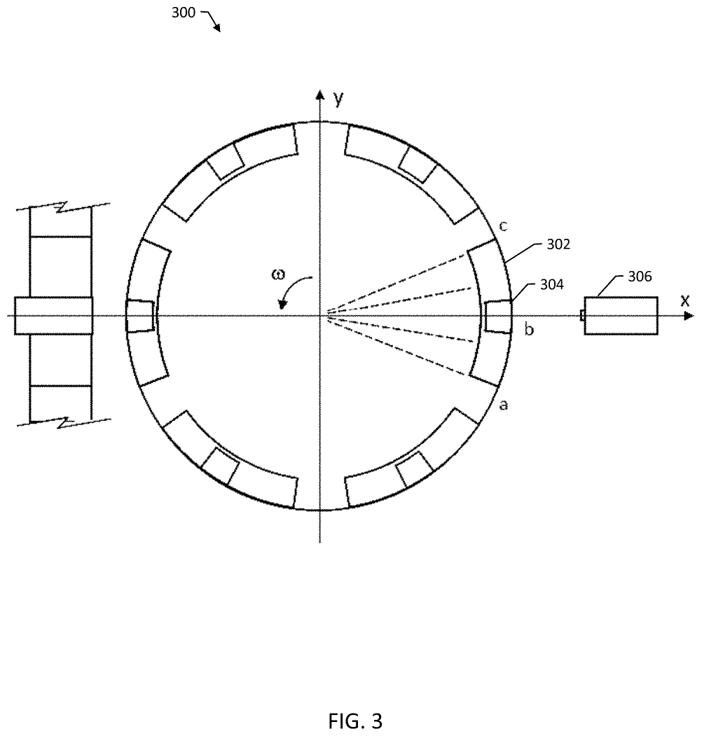

FIG. 3 is a diagram illustrating a system 300 with interleaved reference targets (e.g., target 302) and torque targets (e.g., target 304). As torque is applied to the shaft, the reference and torque targets twist with respect to each other. For example, with positive torque, θ_{ab} will get larger and θ_{bc} will get commensurately smaller. A sensor 306 (e.g., a variable reluctance sensor) disposed as shown will generate voltage pulses as each target a, b, and c pass. Zero crossings associated with these pulses form the basis for target timing. The target sets (each includes targets a, b, and c) are referred to as subrotations and are spaced so that timing between targets can distinguish which segment is passing.

Timing between targets is determined using processor clock counts. For example, the counts between targets a and b are:

cnts_{_ab}=fθ_{ab}/ω

where f is the processor clock speed. For example, if processor clock is 200 MHz, and θ_{ab} is 10 degrees (0.17 rad) and ω is 5000 rpm (520 rad/s), then the clock would generate 66,700 counts between targets a and b. This will determine the resolution of the twist measurement, i.e., the resolution is ω/f in units of rad/count. In the following, the nomenclature τ_{ab} will replace cnt_{_ab}, since time is proportional to counts.

Twist is determined as follows:

where N is the number of target sets (targets a-c) per rotation and where τ_{ab}/τ_{ac} is averaged over a complete rotation as follows:

$${τ}_{ab} / {τ}_{a c} = \frac{1}{N} {\sum }_{k = 1}^{N} {τ}_{a b}^{k} / {τ}_{a c}^{k}$$

$$and$$

$$Δ {θ}_{o} = \frac{2 π}{N} \frac{{τ}_{a b}}{{τ}_{a c}}$$

measured at zero torque

Note that for a given shaft target assembly, τ_{ac} is a function of speed, but is invariable to torque. Also, the factor 2π/N may be derived through calibration steps rather than explicitly calculated.

By considering the ratio τ_{ab}/τ_{ac}, factors such as speed variation, environment (temperature) and aging of the VR sensor are compensated out. Use of this ratio also makes the measurement insensitive to radial motion of the shaft, as will be discussed below.

Ideally the target spacing a-b is nominally different from the target spacing b-c over the entire operating range. This will enable awareness of angular location within a subrotation (where a subrotation if defined as the interval a-b-c).

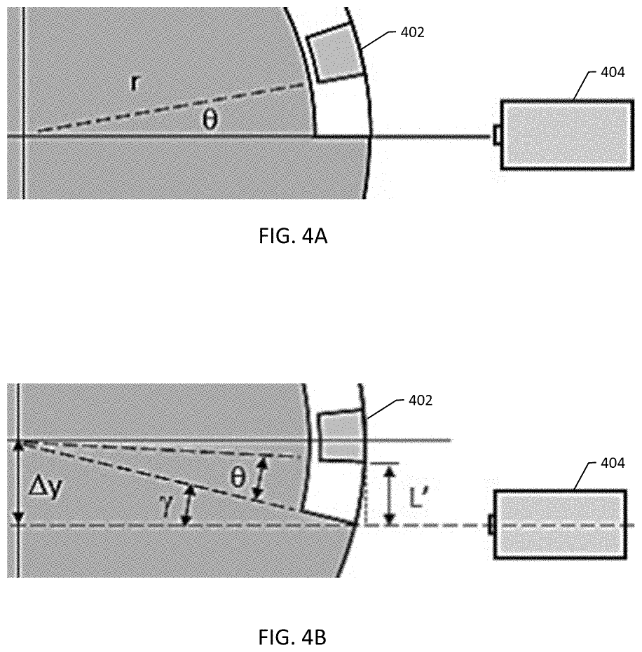

FIGS. 4A and 4B are diagrams illustrating target timing with and without radial offset. A target 402 is shown that passes a sensor 404 as a shaft rotates. Timing error in response to a Δy offset of the VR sensor with respect to the axis of rotation is examined. A Δx offset is assumed to have an impact on VR sensor output amplitude, but minimal effect on target timing since it represents a pure radial offset.

FIGS. 4A and 4B illustrate the impact of a Δy offset. FIG. 4A illustrates perfect alignment (Δy=0) and FIG. 4B defines the geometry associated with a Δy offset. Pulse timing error with radial motion is relatively subtle since the current technique is measuring pulse timing between adjacent teeth as opposed to tooth timing across different measurement planes.

Referring to FIG. 4A, τ_{ab} is the time to travel the distance between targets a and b which in the ideal case has a length of:

L=θr

where θ is the angle between targets a and b. When the VR sensor is offset by Δy, the apparent distance between edges L′ becomes shorter. If Δy is much smaller than r, a second order Maclaurin series can be used to show that

$$γ = Δ y / r$$

$$and$$

$$\frac{{L}^{′}}{L} = 1 - \frac{1}{2} {( \frac{Δ y}{r} )}^{2}$$

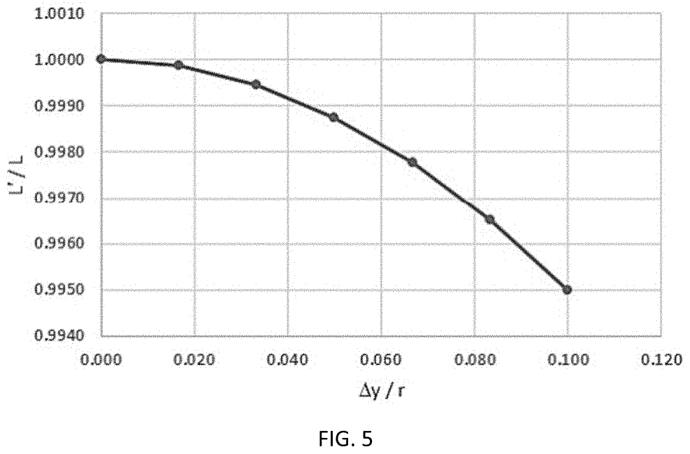

FIG. 5 plots this relationship. FIG. 5 is a chart illustrating tangential length between targets as a function of radial offset. FIG. 5 shows that if the Δy offset is 10% of the target disk radius, then the timing error will be 0.5%. The virtue of considering the ratio τ_{ab}/τ_{ac} is that τ_{ac} experiences the same error in the presence of offset Δy such that

$$\frac{{τ}_{a b}^{′}}{{τ}_{a c}^{′}} = \frac{{τ}_{a b}}{{τ}_{a c}}$$

Therefore, this approach is very robust to radial motion.

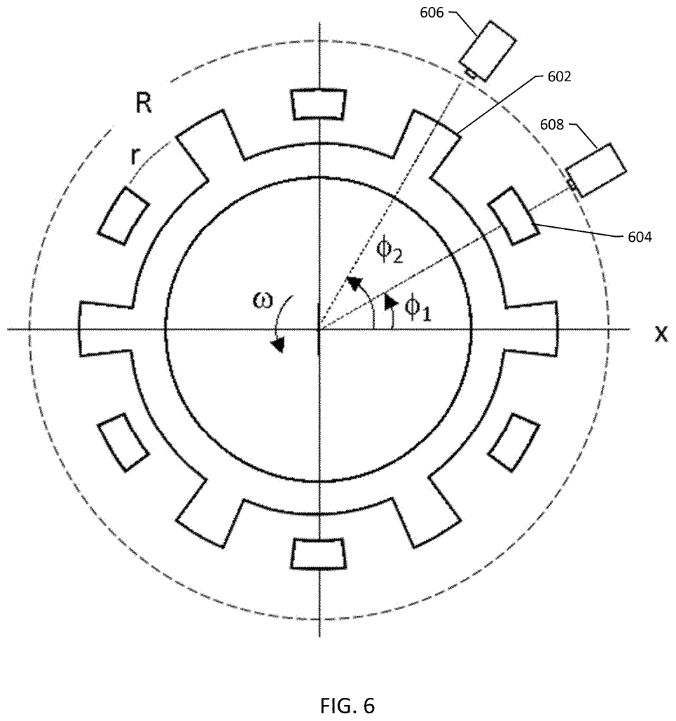

FIG. 6 is a diagram illustrating interleaving targets with two VR sensors. FIG. 6 shows interleaving reference targets (e.g., target 602) and torque targets (e.g., target 604), similar to those presented for the single VR sensor case sown in FIG. 3. In this example, two VR sensors 606 and 608 are nominally oriented to produce voltage pulses simultaneously from a reference target and a torque target. Zero crossings associated with the voltage pulses form the basis for target timing.

Unlike the previous embodiment where a single VR sensor is used, a phase measurement between sensors is used to calculate twist. For example, at nominal shaft radial positions with twist the counts between sensors 1 and 2 is:

Cnts_{_12}=fθ₁₂/ω

where f is the processor clock speed. This may be useful, e.g., by preserving the property of being able to calculate a twist measurement at nearly a discrete instant in time, instead of relying on previous values that have been measured.

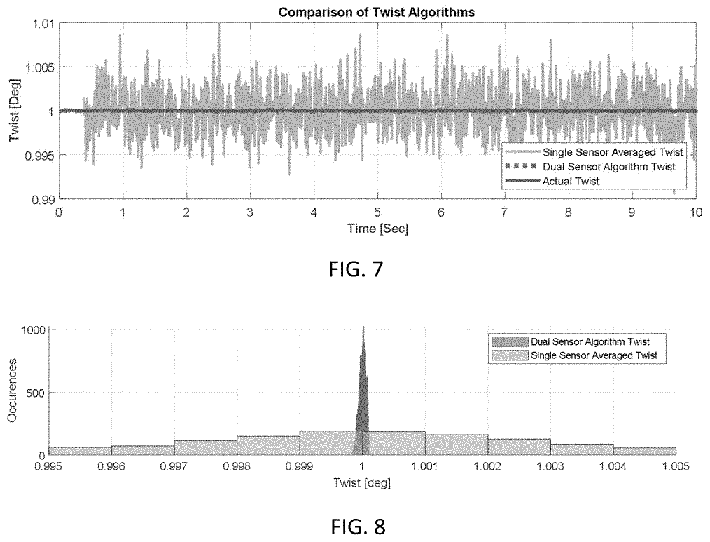

A dual sensor configuration has the added benefit of being able to reject common mode noise with the sensors configured correctly. Consider the case where common mode noise is added to the sensor configuration in FIG. 6. FIG. 7 is a chart showing a time series of twist values that results if the system is simulated at 8000 RPM, 20 teeth, a nominal twist of 1 degree, and 25 clock counts of random common mode noise.

With a dual sensor configuration, using a dual sensor algorithm with the geometry in FIG. 6 allows a much greater rejection of noise as opposed to averaging the measurement of both sensors. This can also be plotted as a histogram independent of time to show the reduction in noise (or increase in SNR).

FIG. 8 is a histogram of twist algorithms with common mode noise. The histogram plot shows that a dual sensor algorithm has a much more concentrated histogram. In this simulation, this results in a standard deviation of 0.00005 deg for the dual sensor algorithm versus a standard deviation of 0.0027 deg for the average of two sensors using a single sensor algorithm.

Note that it is configuration dependent on whether the noise improvements from a dual sensor configuration are necessary for a given application.

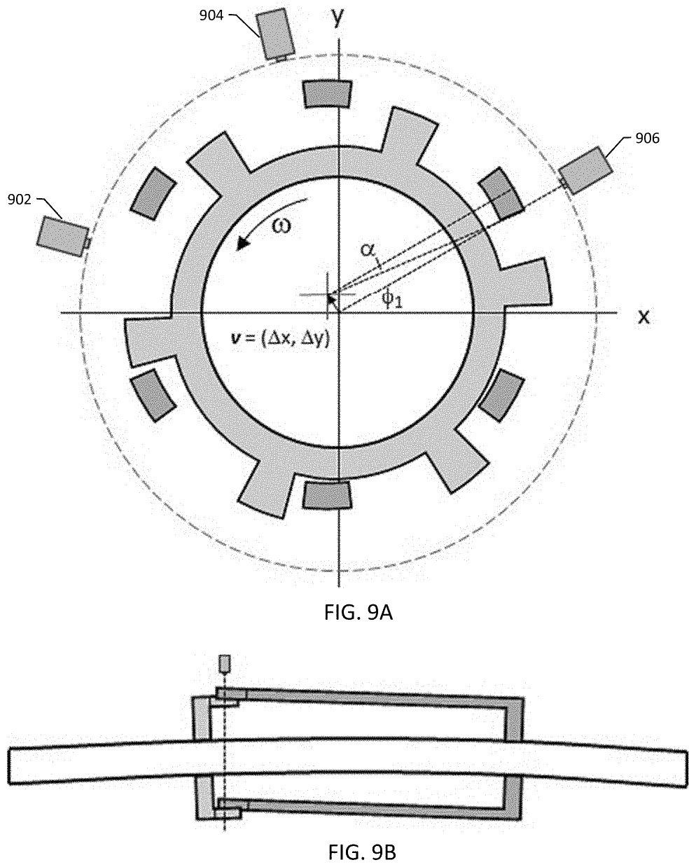

FIGS. 9A and 9B illustrate accommodating relative radial offset between target wheels. Deformation of the primary or reference shaft may result in differential radial misalignment between the reference and torque targets. FIGS. 9A-9B show an exaggerated case of such misalignment which is defined by the vector v=(Δx, Δy). This misalignment will result in an angular distortion a that will look like apparent twist and thus result in torque measurement error.

Typically the reference shaft will be supported by a radial bearing in order to minimize radial misalignment. However, even small tolerances in a bearing can result in measurable error. For example, radial misalignment of v/r=0.0005 can result in up to 0.04 degrees of twist error.

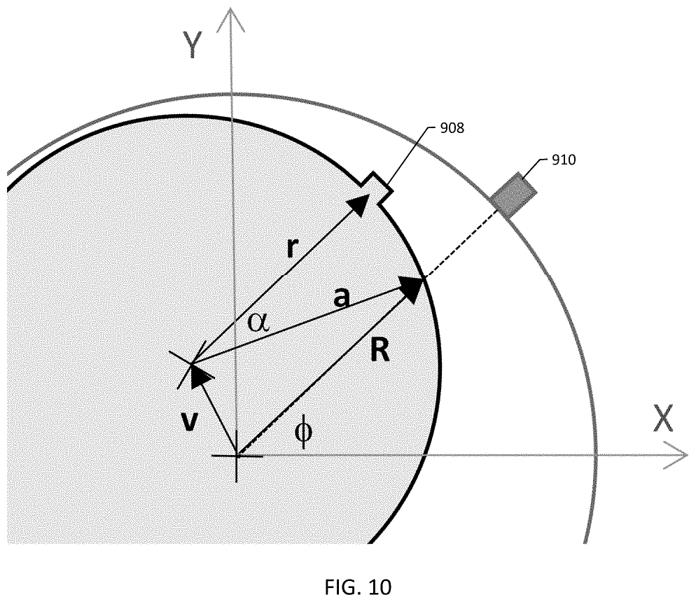

By placing three VR sensors 902, 904, and 906 in a plane and oriented at ϕ₁, ϕ₂ and ϕ₃, the radial misalignment can be measured, and its effect can be removed from the true twist measurement. FIG. 10 zooms in on a single target 908 and VR sensor 910 and provides associated vector math to compute angular distortion α.

$$V = ( Δ x , Δ y )$$

$$r = ( r cos ϕ , r sin ϕ )$$

$$R = ( q cos ϕ , q sin ϕ ) , where q = r + Δ y sin ϕ + Δ x cos ϕ$$

$$a = R - v = ( q cos ϕ - Δ x , q sin ϕ - Δ y )$$

$$cos α = \frac{r \cdot a}{‖ r ‖ ‖ a ‖}$$

For small radial misalignments (e.g., |v|/r<0.1), the angular distortion can be approximated as

α ≈ Δy/r cos ϕ−Δx/r sin ϕ

Twist measured by each sensor is computed as previously indicated. However, for each VR sensor, the measured twist will be the sum of actual twist and the angular distortion:

Δθᵢ=Δθ+αᵢ ≈ Δθ+Δy/r cos ϕᵢ−Δx/r sin ϕᵢ, for i=1, 2, 3

Now, radial misalignment and true twist can be computed by inverting the following equation:

$$[ \begin{matrix}Δ {θ}_{1} \\ Δ {θ}_{2} \\ Δ {θ}_{3}\end{matrix} ] = [ \begin{matrix}1 & - 1 / r sin {φ}_{1} & 1 / r cos {φ}_{1} \\ 1 & - 1 / r sin {φ}_{2} & 1 / r cos {φ}_{2} \\ 1 & - 1 / r sin {φ}_{3} & 1 / r cos {φ}_{3}\end{matrix} ] [ \begin{matrix}Δ θ \\ Δ x \\ Δ y\end{matrix} ]$$

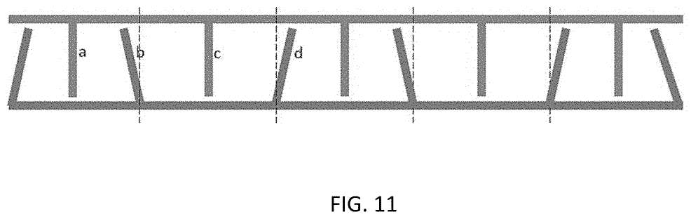

FIG. 11 illustrates angled targets to enable measurement of axial motion. Now targets a-b-c-d comprise one subrotation where there are an integer number of subrotations per rotation. The specific pattern of alternating slanted teeth is configured to ensure a disambiguous timing pattern that can provide information of the position within the subrotation.

The angled targets are at alternating angles so that twist can be calculated by averaging timing ratios within each subrotation over an entire rotation in a manner analogous to that shown above. In particular, twist is determined as follows:

$$Δ θ = \frac{2 π}{{N}^{2}} {\sum }_{k = 1}^{N} ( {τ}_{ab}^{k} / {τ}_{a c}^{k} + {τ}_{c d}^{k} / {τ}_{c a}^{k} ) - Δ {θ}_{∘}$$

where N is the number of subrotations (targets a-b-c-d) per rotation, and

$$Δ {θ}_{o} = \frac{2 π}{{N}^{2}} {\sum }_{k = 1}^{N} ( {τ}_{ab}^{k} / {τ}_{a c}^{k} + {τ}_{c d}^{k} / {τ}_{c a}^{k} )$$

measured at zero torque

Axial motion Δz can be calculated by averaging over only the first half (or second half) of each subrotation

$$Δ z = β \frac{1}{N} {\sum }_{k = 1}^{N} {τ}_{a b}^{k} / {τ}_{a c}^{k} - Δ {z}_{0}$$

where
Δzₒ=β τ_{ab}/τ_{ac} measured at zero axial motion

and where β is a constant that converts the pulse time ratio to axial motion

$$β = \frac{2 π r}{N tan γ}$$

where γ is the target angles. It should be appreciated that the target pattern is configured in the above geometry such that the controller can always determine target “a” within a subrotation.

Note that this axial motion measurement measures relative axial motion between the VR sensor and a single plane on the shaft.

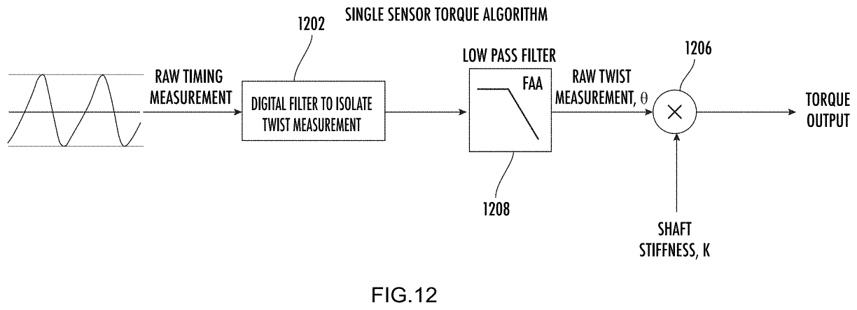

FIG. 12 is a signal processing diagram for a system configured to calculate the torque applied to a shaft. The signal processing is configured for isolating the effect of twist on the timing pattern of the shaft. The signal processing includes a digital filter 1202 configured to isolate a twist measurement from a raw timing measurement. The signal processing includes a low pass filter 1204 configured to output a raw twist measurement. The signal processing includes a combiner 1206 to use a measurement of shaft stiffness with the twist measurement to produce a torque output.

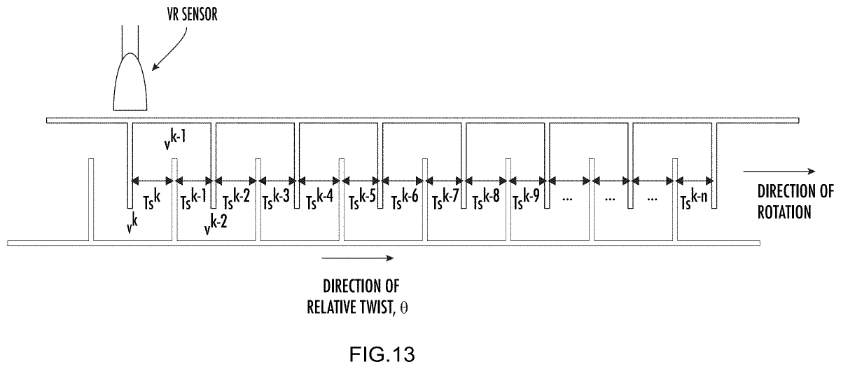

FIG. 13 is a diagram showing an unraveled set of targets passing a VR sensor. The timing pattern between the teeth can be written as a series of timing values based on the period of time between two successive tooth passages (or zero crossings).

In the example shown in FIG. 13, the instant in time that each tooth passes (v^{k}) can be written as the following:

$${v}^{k} = \{ \begin{matrix}\frac{{f}_{clock}}{N} {\int }_{0}^{k} \frac{{dk}^{′}}{{f}_{shaft}^{{k}^{′}}} + \frac{{f}_{clock}}{{f}_{shaft}^{k}} \frac{θ}{2 π} & ( where k is odd ) \\ \frac{{f}_{clock}}{N} {\int }_{0}^{k} \frac{{dk}^{′}}{{f}_{shaft}^{{k}^{′}}} & ( where k is even )\end{matrix}$$

Where f_{clock} is the clock speed of the timing measurement, N is the total number of teeth, k is the discrete index in time, f_{shaft} is the shaft speed at time instant k, and θ is the shaft twist. This can be further simplified if the shaft speed, f_{shaft}, is roughly constant.

$${v}^{k} = \{ \begin{matrix}\frac{{f}_{clock}}{N} \frac{k}{{f}_{shaft}} + \frac{{f}_{clock}}{{f}_{shaft}^{k}} \frac{θ}{2 π} & ( where k is odd ) \\ \frac{{f}_{clock}}{N} \frac{k}{{f}_{shaft}} & ( where k is even )\end{matrix}$$

The timing value at each discrete index in time, Ts^{k}, can be written as the following (with shaft speed f_{shaft} assumed to be constant over the small time interval between teeth):

$$T {s}^{k} = {v}^{k} - {v}^{k - 1} = \frac{{f}_{clock}}{{f}_{shaft}} ( \frac{1}{N} + \frac{{( - 1 )}^{k} θ}{2 π} )$$

Note that the final result of this equation applies to all discrete indices of k. The effect of twist on an interleaved pattern of teeth results in a timing change that adds to one time period and subtracts from the next; this pattern repeats every revolution. A series of digital filtering can therefore isolate the twist. The Twist over an entire revolution can be calculated by adding and subtracting all of the timing values.

$${\sum }_{n ==}^{n = N - 1} {( - 1 )}^{n} {Ts}^{k - n} = {Ts}^{k} - {Ts}^{k - 1} + {Ts}^{k - 2} - {Ts}^{k - 3} + … + {Ts}^{k - N - 2} - {Ts}^{k - N - 1} = - \frac{{f}_{clock}}{{f}_{shaft}} \frac{θ}{π} \frac{N}{2}$$

Rewriting this equation and solving for θ results in the following:

$${θ}^{k} = \frac{- 2 π}{N} \frac{{f}_{shaft}}{{f}_{clock}} {\sum }_{n = 0}^{n = N - 1} {( - 1 )}^{n} T {s}^{k - n}$$

This can also be rewritten as a digital FIR filter with the following coefficients for a case where there are N=12 teeth. This digital FIR filter is an example of the digital filter 1202 for isolating twist.

$$B = \frac{- 2 π}{12} \frac{{f}_{shaft}}{{f}_{clock}} [ 1 - 1 \; 1 - 1 \; 1 - 1 \; 1 - 1 \; 1 - 1 \; 1 - 1 ]$$

In practice, this value of θ should be designed to always be positive, and should also be filtered down to a lower bandwidth with an anti-aliasing filter, F_{AA}; it is also helpful to apply a calibration offset θ₀ to adjust for any real world imperfections in the amount of twist.

θ=F_{AA}|θ^{k}|−θ₀

After performing filtering operation, the shaft torsional stiffness, K, can be multiplied in to determine torque, T:

T=K(θ−θ₀)

Similarly, this signal processing can also be augmented to detect axial motion of the shaft. It uses the addition of a specific slant pattern in the teeth, and an additional digital filter used to isolate the effects of the slanted teeth.

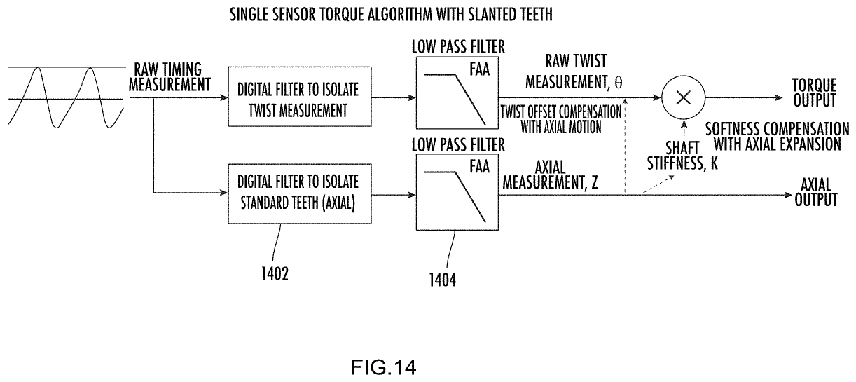

FIG. 14 is a signal processing diagram for a system augmented to detect axial motion. The signal processing includes a parallel path includes a digital filter 1402 to isolate slanted teeth and a low pass filter 1404 to output an axial measurement. The axial measurement can be used for compensation of the twist measurement and the shaft stiffness to improve the torque output.

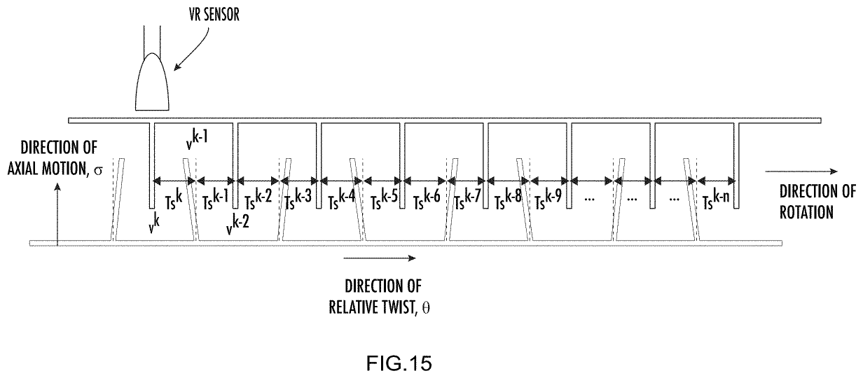

FIG. 15 is a diagram showing an unraveled set of targets passing a VR sensor. Similar to the case with straight teeth, described above with reference to FIG. 13, the timing at each tooth passage can be written in the following form with the addition of a term to account for the effect of the axial motion and the slants of the teeth:

$${v}^{k} = \{ \begin{matrix}\begin{matrix}\frac{{f}_{clock}}{N} {\int }_{0}^{k} \frac{{dk}^{′}}{{f}_{shaft}^{{k}^{′}}} + \frac{{f}_{clock}}{{f}_{shaft}^{k}} \frac{θ}{2 π} + \\ \frac{{f}_{clock}}{{f}_{shaft}^{k}} \frac{z}{2 π r} tan ( β \times {( - 1 )}^{( k - 1 ) / 2} )\end{matrix} & ( where k is odd ) \\ \frac{{f}_{clock}}{N} {\int }_{0}^{k} \frac{{dk}^{′}}{{f}_{shaft}^{{k}^{′}}} & ( where k is even )\end{matrix}$$

Where f_{clock} is the clock speed of the timing measurement, N is the total number of teeth, k is the discrete index in time, and f_{shaft} is the shaft speed at time instant k, and θ is the shaft twist. Additional parameters introduced to represent axial motion include z, the axial displacement, r the radius of the targets that are on the shaft, and β which is the angle of the tooth slants. While it is possible to make these slants non-uniform, the signal processing complexity is reduced if the slant is equal and opposite in the pattern shown above and the slant is a small angle. This can be further simplified if the shaft speed, f_{shaft}, is roughly constant over the small time interval between teeth.

$${v}^{k} = \{ \begin{matrix}\begin{matrix}\frac{{f}_{clock}}{N} \frac{k}{{f}_{shaft}} + \frac{{f}_{clock}}{{f}_{shaft}^{k}} \frac{θ}{2 π} + \\ \frac{{f}_{clock}}{{f}_{shaft}} \frac{z}{2 π r} tan ( β \times {( - 1 )}^{( k - 1 ) / 2} )\end{matrix} & ( where k is odd ) \\ \frac{{f}_{clock}}{N} \frac{k}{{f}_{shaft}} & ( where k is even )\end{matrix}$$

The timing value at each discrete index in time, Ts^{k}, can be written as the following (with shaft speed f_{shaft} assumed to be constant) pattern that repeats where m is an integer (1, 2, 3, . . . ).

$$T {s}^{k - 0} = T {s}^{k - 0 - 4 m} = {v}^{k - 0} - {v}^{k - 1} = \frac{{f}_{clock}}{{f}_{shaft}} ( \frac{1}{N} - \frac{θ}{2 π} + \frac{z}{2 π r} tan β )$$

$$T {s}^{k - 1} = T {s}^{k - 1 - 4 m} = {v}^{k - 1} - {v}^{k - 2} = \frac{{f}_{clock}}{{f}_{shaft}} ( \frac{1}{N} + \frac{θ}{2 π} - \frac{z}{2 π r} tan β )$$

$$T {s}^{k - 2} = T {s}^{k - 2 - 4 m} = {v}^{k - 2} - {v}^{k - 3} = \frac{{f}_{clock}}{{f}_{shaft}} ( \frac{1}{N} - \frac{θ}{2 π} - \frac{z}{2 π r} tan β )$$

$$T {s}^{k - 3} = T {s}^{k - 3 - 4 m} = {v}^{k - 3} - {v}^{k - 4} = \frac{{f}_{clock}}{{f}_{shaft}} ( \frac{1}{N} + \frac{θ}{2 π} + \frac{Z}{2 π r} tan β )$$

Or more simply,

$$T {s}^{k} = \frac{{f}_{clock}}{{f}_{shaft}} ( \frac{1}{N} - \frac{{( - 1 )}^{k} θ}{2 π} + \frac{{( - 1 )}^{k ( k + 1 ) / {2}_{z}}}{2 π r} tan β )$$

Note that the calculation for twist remains the same, and axial motion does not affect nominally affect this measurement of twist:

$${θ}^{k} = \frac{- 2 π}{N} \frac{{f}_{shift}}{{f}_{clock}} {\sum }_{n = 0}^{n = N - 1} {( - 1 )}^{n} T {s}^{k - n}$$

$$θ = {F}_{A A} \vert {θ}_{k} \vert - {θ}_{0}$$

$$T = K ( θ - {θ}_{0} )$$

The axial displacement over an entire revolution can be calculated by adding and subtracting all of the timing values.

$${\sum }_{m = 0}^{m = N / 4 - 1} T {s}^{k - 4 m} - T {s}^{k - 1 - 4 m} - T {s}^{k - 2 - 4 m} + T {s}^{k - 3 - 4 m} = {Ts}^{k} - {Ts}^{k - 1} - {Ts}^{k - 2} + {Ts}^{k - 3} + … + {Ts}^{k - N - 4} - {Ts}^{k - N - 3} - {Ts}^{k - N - 2} + {Ts}^{k - N - 1} = N \frac{{f}_{clock}}{{f}_{shaft}} \frac{z}{2 π r} tan β$$

Rewriting this equation and solving for z results in the following:

$${z}^{k} = \frac{2 π r}{N tan ( β )} \frac{{f}_{shift}}{{f}_{clock}} {\sum }_{m = 0}^{m = N / 4 - 1} T {s}^{k - 4 m} - T {s}^{k - 1 - 4 m} - T {s}^{k - 2 - 4 m} + T {s}^{k - 3 - 4 m}$$

This can also be rewritten as a digital FIR filter with the following coefficients for a case where there are N=12 teeth. This digital FIR filter is an example of the digital filter 1404 for isolating axial motion.

$$B = \frac{2 π R}{12 tan ( β )} \frac{{f}_{shift}}{{f}_{clock}} [ 1 - 1 - 1 \; 1 \; 1 - 1 - 1 \; 1 \; 1 - 1 - 1 \; 1 ]$$

In practice, this value of z should be designed to always be positive, and should also be filtered down to a lower bandwidth with an anti-aliasing filter, F_{AA}; it is also helpful to apply a calibration offset z₀ to adjust for any real world imperfections in the axial location.

z=F_{AA}|z^{k}|−z₀

Due to real-world machining tolerances, the twist value measured may change as the axial measurement changes. This would adjust the twist offset to be a function of the axial measurement (denoted θ₀{z}).

T=K(θ−θ₀{z})

In addition, depending on the mechanical construction of the shaft, temperature variation may increase proportionally with the axial measurement. In order to remove a temperature sensor, the axial measurement can be used to adjust the stiffness as a function of the axial measurement, denoted K{z} (instead of being a function of temperature). This would adjust the Torque calculation as follows:

T=K{z}(θ−θ₀{z})

Similar to the single sensor torque calculation, a dual sensor configuration can be used to achieve additional accuracy. This involves placing one of the two sensors over opposite sets of the interleaved teeth, for example, as shown in FIG. 6.

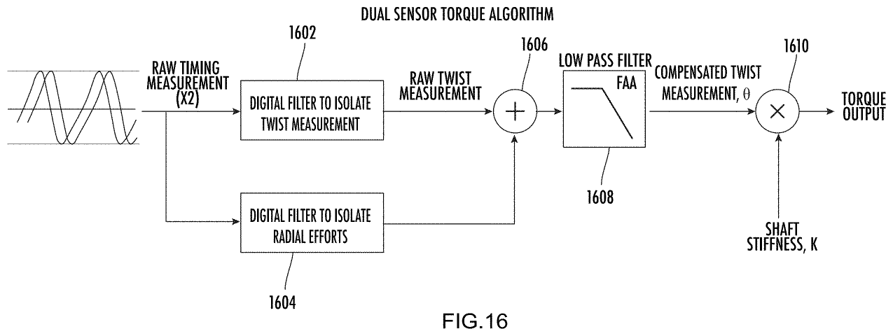

FIG. 16 is a signal processing diagram of a system configured for processing two sensor signals to achieve a more accurate torque measurement. The signal processing includes a digital filter 1602 to isolate a twist measurement from a raw timing measurement, a digital filter 1604 to isolate radial effects, and a combiner 1606. The output of the combiner 1606 is input to a low pass filter 1608 that outputs a compensated twist measurement. The signal processing includes another combiner 1610 to use a measurement of shaft stiffness to generate a torque output.

In general, these effects become more important as overall twist on the shaft becomes small, such as 0.5 degrees. At large gaps, e.g., >0.2″ there is a noise improvement utilizing two sensors for measurement. Some magnetic effects from multiple sensors cause phase shifts in the twist measurement with radial motion. Multiple sensors can be used such that this effect (observed on the order of 0.030 degrees) to be reduced to negligible levels (e.g., 0.004 degrees).

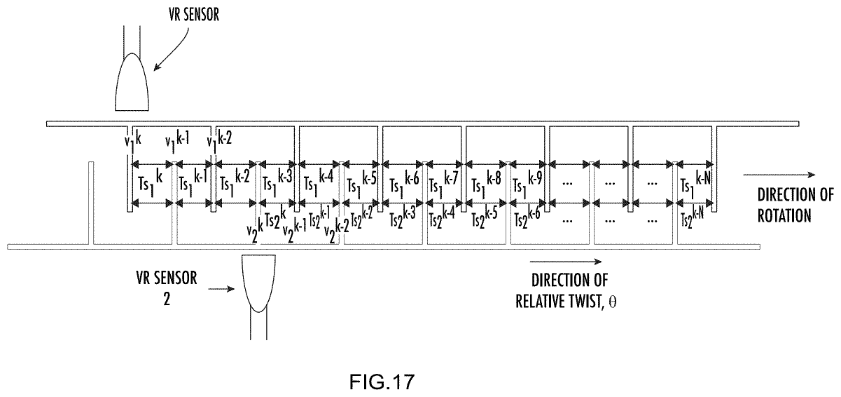

FIG. 17 is a diagram showing an unraveled set of targets passing two VR sensors. In the example shown in FIG. 17, the instant in time that each tooth passes (v^{k}) can be written as the following (note that this is now a vector quantity representing two sensors):

$$[ \begin{matrix}{v}_{1}^{k} \\ {v}_{2}^{k}\end{matrix} ] = \{ \begin{matrix}[ \begin{matrix}1 \\ 1\end{matrix} ] \frac{{f}_{clock}}{N} {\int }_{0}^{k} \frac{{dk}^{′}}{{f}_{shaft}^{{k}^{′}}} + \frac{{f}_{clock}}{{f}_{shaft}^{k}} \frac{1}{2 π} [ \begin{matrix}θ \\ 0\end{matrix} ] & ( where k is odd ) \\ [ \begin{matrix}1 \\ 1\end{matrix} ] \frac{{f}_{clock}}{N} {\int }_{0}^{k} \frac{{dk}^{′}}{{f}_{shaft}^{{k}^{′}}} + \frac{{f}_{clock}}{{f}_{shaft}^{k}} \frac{1}{2 π} [ \begin{matrix}0 \\ θ\end{matrix} ] & ( where k is even )\end{matrix}$$

Where f_{clock} is the clock speed of the timing measurement, N is the total number of teeth, k is the discrete index in time, and f_{shaft} is the shaft speed at time instant k, and θ is the shaft twist. This can be further simplified if the shaft speed, f_{shaft}, is roughly constant over the small time interval between teeth.

$$[ \begin{matrix}{v}_{1}^{k} \\ {v}_{2}^{k}\end{matrix} ] = \{ \begin{matrix}[ \begin{matrix}1 \\ 1\end{matrix} ] \frac{{f}_{clock}}{N} \frac{k}{{f}_{shaft}} + \frac{{f}_{clock}}{{f}_{shaft}} \frac{1}{2 π} [ \begin{matrix}θ \\ 0\end{matrix} ] & ( where k is odd ) \\ [ \begin{matrix}1 \\ 1\end{matrix} ] \frac{{f}_{clock}}{N} \frac{k}{{f}_{shaft}} + \frac{{f}_{clock}}{{f}_{shaft}} \frac{1}{2 π} [ \begin{matrix}0 \\ θ\end{matrix} ] & ( where k is even )\end{matrix}$$

The timing value between the two sensors, denoted dab^{k}, can be written as the following (with shaft speed f_{shaft} assumed to be constant) and is a measurement of twist:

$$d a {b}^{k} = {v}_{1}^{k} - {v}_{2}^{k} = {( - 1 )}^{k} \frac{{f}_{clock}}{{f}_{shaft}} \frac{- θ}{2 π}$$

Note that the final result of this equation applies to all discrete indices of k. The effect of twist on an interleaved pattern of teeth results in a timing change that is an alternating positive and negative value of twist; this pattern repeats every revolution. A series of digital filtering can therefore isolate the twist. The twist over an entire revolution can be calculated by adding and subtracting all of the timing values. This equation forms the basis of the filtering coefficients for the digital filter 1602 for isolating twist with two sensors.

$${\sum }_{n = 0}^{n = N - 1} {( - 1 )}^{n} d a {b}^{k - n} = {dab}^{k} - {dab}^{k - 1} + {dab}^{k - 2} - {dab}^{k - 3} + … + {dab}^{k - N - 2} - {dab}^{k - N - 1} = - \frac{{f}_{clock}}{{f}_{shaft}} \frac{θ}{π} \frac{N}{2}$$

However, in experimental testing, radial motion effects did cause slight phase shifts in the VR sensor Zero-Crossing measurement. The above calculation is a raw twist measurement that requires some adjustment as the target wheel moves radially, this allows a correction of the twist accuracy to levels that are sub 0.004 degrees accurate. This radial correction factor can be isolated by looking at an individual target passing both sensors.

The timing value between the two sensors looking at one side of targets, denoted dabz1^{k}, can be written as the following (with shaft speed f_{shaft} assumed to be constant):

$$d a b z {1}^{k} = {v}_{1}^{k} - {v}_{2}^{k - 1} = {v}_{1}^{k} - {v}_{2}^{k} {z}^{- 1} = \frac{{f}_{clock}}{N {f}_{shaft}}$$

Note that this value should remain constant, however, in practice the value changes as the radial position of the shaft or sensor changes, because of this observed fact, this value can be used to compensate the twist measurement and provide a more accurate torque value. This equation forms the basis of the filtering coefficients for the digital filter 1604 for isolating radial motion with two sensors. Filtering over a revolution gives the following relationship:

$$DABZ {1}^{k} = \vert \frac{1}{N} {\sum }_{n = 0}^{n = N - 1} dabz {1}^{k - n} \vert$$

In practice, a more accurate twist measurement can be calculated with the following relationship:

$${θ}_{c o m p}^{k} = {θ}_{raw}^{k} - G \times \frac{2 π {f}_{shaft}}{{f}_{clock}} DABZ {1}^{k}$$

Where G is a scalar value or lookup table that depends on any of the following values: shaft speed, temperature, or the value of DABZ1^{k} (if it ends up being a non-linear relationship). In practice, this compensated value of θ should be filtered down to a lower bandwidth with an anti-aliasing filter, F_{AA}; it is also helpful to apply a calibration offset θ₀ to adjust for any real world imperfections in the amount of twist.

θ=F_{AA}|θ_{comp}^{k}|−θ₀

Exactly as before, the shaft torsional stiffness, K, can be multiplied in to determine torque, T:

T=K(θ−θ₀)

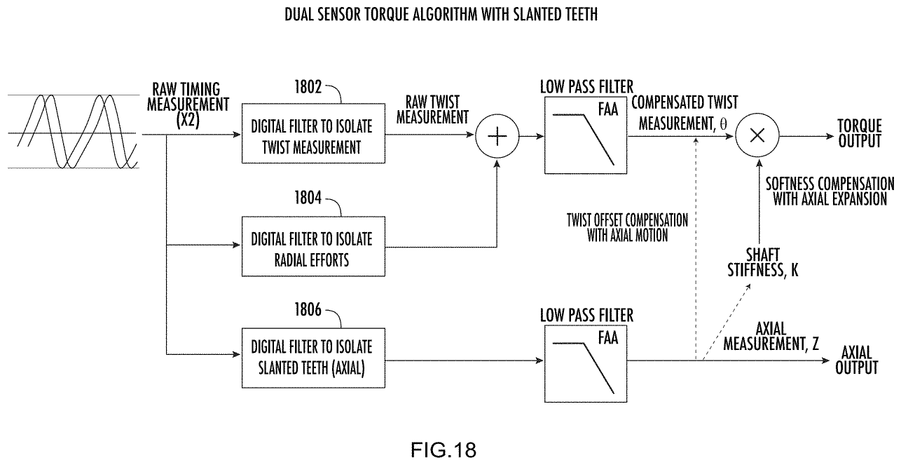

Similar to previous concepts, Axial (or other) motions can be measured by incorporated slanted teeth with a single sensor. This process can also be followed with a two sensor setup where the axial measurement can be used to further compensate the dual sensor twist measurement by providing an additional calibration offset for the twist measurement, θ, and/or providing an alternate measurement to temperature for compensating the stiffness, K. FIG. 18 is a signal processing diagram for an example system using dual sensors and axial/slanted teeth to output torque. The system includes a digital filter 1802 to isolate a twist measurement, a digital filter 1804 to isolate radial effects, and a digital filter 1806 to isolate axial effects.

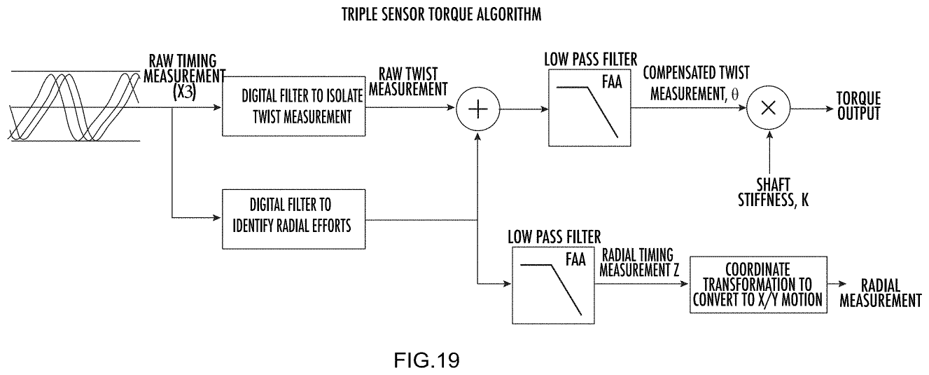

Similar to the dual sensor torque concept with straight teeth, three sensors can be used to determine a more accurate torque. With three sensors, the exact x/y position of the shaft or cradle can be ascertained. This also allows a slightly more accurate compensation of the twist measurement, θ. For example, U.S. Pat. No. 7,093,504 describes methods for determining x/y motion from three sensors. U.S. Pat. No. 7,093,504 is hereby incorporated by reference in its entirety. FIG. 19 is a signal processing diagram for an example system using three sensors.

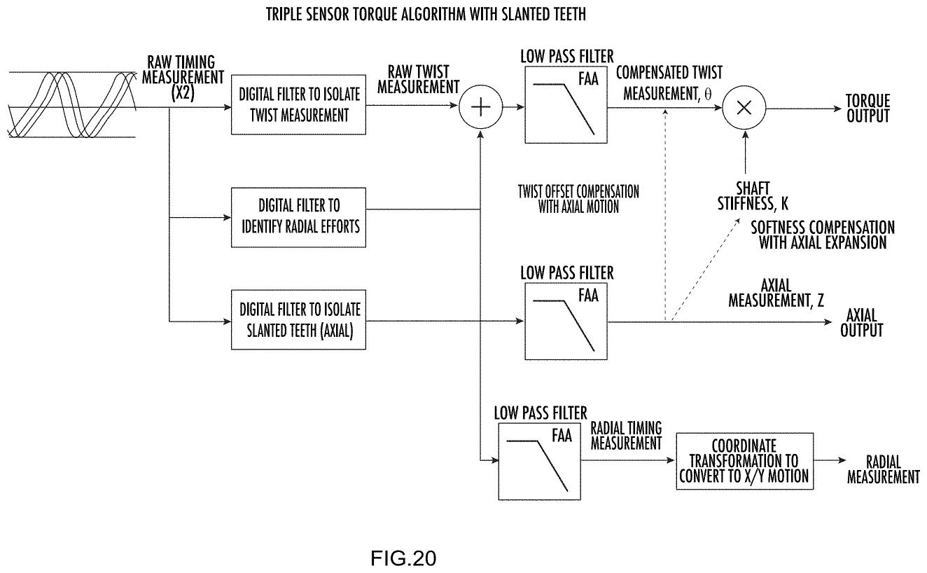

A combination of three or more sensors and axially slanted teeth will allow the determination of x/y position of the shaft or cradle and the axial position as well. This allows an accurate compensation of the twist measurement θ with radial position and axial position. It also provides an alternate measurement to temperature for compensating the stiffness, K. FIG. 20 is a signal processing diagram for an example system for triple sensor torque with axial/slanted teeth.

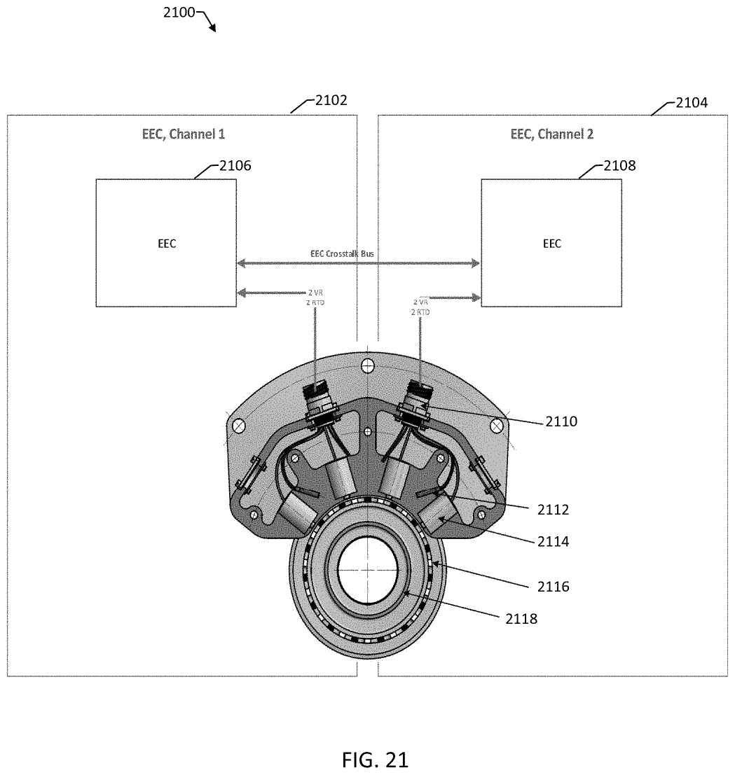

FIG. 21 is a block diagram of an example system 2100 for redundantly calculating a torque applied to the shaft to meet a safety criticality threshold of accuracy. The system 2100 includes two channels 2102 and 2104 for calculating a torque applied to the shaft. The sensor processing unit can be implemented as two separate systems for calculating torque from two separate sets of one or more sensors. For example, the sensor processing unit can be implemented an electronic engine controller (EEC) or full authority digital engine controller (FADEC). In the system 2100 shown in FIG. 21, there may be space for quadruple or triple redundant sensors sets without extra axial length due to each sensor set occupying a single axial location.

As shown in FIG. 21, the first channel 2102 includes an EEC 2106 and the second channel 2104 includes another EEC 2108. Each of the channels 2102 and 2104 uses a connector 2110 for a sensor, e.g., a MIL-DTL-38999 connector. Each of the channels 2102 and 2104 includes at least one temperature sensor 2112, e.g., one or more RTD sensors. Each of the channels 2102 and 2104 includes at least one sensor 2114, e.g., one or more VR sensors. The system 2100 includes interleaved targets 2116, and FIG. 21 illustrates a shaft torque load path 2118.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A system for measuring twist on a shaft of a rotating drive system, the system comprising:
a first set of targets circumferentially distributed around the shaft at a first axial location and configured to rotate with the shaft;
a second set of targets circumferentially distributed around the shaft at a second axial location and configured to rotate with the shaft, wherein the first and second sets of targets are interleaved;
a sensor assembly comprising one or more sensors mounted around the shaft and configured to detect the first and second sets of targets as the shaft rotates; and
a sensor processing unit configured for:
receiving an electrical waveform from the sensor assembly;
determining, based on the electrical waveform, a twist measurement of twist motion between the first axial location and the second axial location on the shaft; and
determining, based on the electrical waveform, a second measurement of shaft motion.

2. The system of claim 1, wherein each target of the first and second sets of targets comprises a ferrous target, and wherein each sensor of the one or more sensors comprises a variable reluctance sensor.

3. The system of claim 1, wherein a subset of the targets is slanted in an axial direction and determining the second measurement comprises determining axial motion.

4. The system of claim 1, wherein the sensor processing unit is configured for determining a timing of a passage of each target of the first and second sets of targets and determining the twist measurement based on the timings, and wherein determining the twist measurement comprises determining a ratio between:
a first timing between adjacent targets of the first and second sets of targets; and
a second timing between adjacent targets of the first set of targets or the second set of targets or both.

5. The system of claim 4, wherein determining the twist measurement comprises averaging twist motion using the ratio over an integer number of shaft rotations.

6. The system of claim 1, wherein the sensor processing unit is configured for using the second measurement of shaft motion to improve the accuracy of the twist measurement.

7. The system of claim 1, wherein determining the second measurement of shaft motion comprises determining a measurement of radial motion of the shaft based on the electrical waveform from the sensor assembly.

8. The system of claim 1, wherein determining the twist measurement comprises determining the twist measurement based on a radial motion of the shaft.

9. The system of claim 1, wherein the sensor assembly comprises at least two sensors positioned within a single axial plane between the first axial location and the second axial location on the shaft, and wherein the at least two sensors are positioned at azimuth locations such that each of the at least two sensors is configured to produce a respective electrical waveform from one or the other of the first and second set of targets.

10. The system of claim 9, wherein determining the twist measurement comprises determining a difference in timing target passages from the first and second sets of sensors and substantially rejecting common mode noise.

11. The system of claim 9, wherein the two sensors are located such that each sensor is mounted uniquely over each of the first and second set of targets.

12. The system of claim 1, wherein determining the second measurement of shaft motion comprises determining a speed of shaft motion.

13. The system of claim 1, wherein the sensor assembly comprises two or more sensors, and wherein determining the second measurement comprises determining a difference in timing between the two or more sensors, and wherein determining the twist measurement comprises using the difference in timing between the two or more sensors to correct the twist measurement for axial and/or radial motion.

14. The system of claim 1, wherein the sensor processing unit is configured for calculating a torque applied to the shaft using the twist measurement and a shaft torsional stiffness.

15. The system of claim 1, wherein the sensor processing unit is configured for redundantly calculating a torque applied to the shaft to meet a safety criticality threshold of accuracy.

16. The system of claim 1, wherein the sensor processing unit is configured for cross checking a calculated torque with two or more sensors.

17. The system of claim 1, wherein the sensor assembly comprises three or more sensors, and wherein the sensor processing unit is configured for using the three or more sensors to calculate an XY position of the shaft.

18. The system of claim 1, comprising at least one temperature sensor, wherein the signal processing unit is configured to use a temperature signal from the temperature sensor in determining the twist measurement or in determining a stiffness of the shaft or both.

19. The system of claim 1, wherein the sensor processing unit comprises an electronic engine controller (EEC) or full authority digital engine controller (FADEC).

20. A method for measuring twist on a shaft of a rotating drive systems, the method comprising:
receiving an electrical waveform from a sensor assembly, the sensor assembly comprising one or more sensors mounted around the shaft and configured to detect first and second sets of targets as the shaft rotates, wherein the first set of targets is circumferentially distributed around the shaft at a first axial location and configured to rotate with the shaft and wherein the second set of targets is circumferentially distributed around the shaft at a second axial location and configured to rotate with the shaft, wherein the first and second sets of targets are interleaved;
determining, based on the electrical waveform, a twist measurement of twist motion between the first axial location and the second axial location on the shaft; and
determining, based on the electrical waveform, a second measurement of shaft motion.
